(19) United States
(12) Patent Application Publication
(10) Pub. No.: US 2022/0282688 A1
(43) Pub. Date: Sep. 8, 2022

(54) ATTENUATORS FOR COMBUSTION NOISE IN DUAL MODE RAMJETS AND SCRAMJETS

(71) Applicant: Raytheon Company, Waltham, MA (US)

(72) Inventor: Adam A. Trebs, Tucson, AZ (US)

(21) Appl. No.: 17/194,635

(22) Filed: Mar. 8, 2021

(51) Int. Cl. F02K 7/14

(52) U.S. Cl. CPC F02K 7/14; F05D 2220/80; F05D 2260/96

(57) ABSTRACT

A dual mode ramjet or scramjet engine used in the propulsion of an aircraft includes an inlet configured to receive and compress air, a combustion chamber connected to the inlet and configured to mix the compressed air with fuel to pressurize the dual mode ramjet or scramjet engine, and an acoustic attenuator having one or more resonator cavities integrated into the combustion chamber.

### FIELD OF DISCLOSURE

The disclosure relates to an acoustic attenuator for a dual mode ramjet or scramjet.

### DESCRIPTION OF THE RELATED ART

A dual mode ramjet or scramjet is a ramjet engine which operates in two modes that are dependent on the flight Mach number. In a first mode, the dual mode ramjet operates as a ramjet with subsonic combustion whereas in a second mode, the dual mode ramjet operates as a scramjet with supersonic combustion. As the dual mode ramjet or scramjet has forward motion, surrounding air enters an inlet of the engine which compresses the air to slow the speed of the air. In a combustion chamber of the engine, heat is added to the compressed air by adding fuel and burning the fuel, such that the density of the air is decreased. Consequently, pressure in the engine rises such that aft surfaces of the engine are pressurized for propulsion of a vehicle in which the engine is arranged. For example, the engine may be mounted to a high speed aircraft for propulsion of the aircraft.

Due to variations in pressure and variations in the distribution of fuel, the combustion process may be noisy and cause unsteadiness of the engine and thus the aircraft. The combustion noise may impart fatigue on the combustion components, reduce combustion performance, and extinguish combustion. The noise generation may also be severe enough that the noise becomes a dominant noise source in the aircraft that is detrimental to avionics and actuators in the aircraft, i.e. components outside of the engine.

### SUMMARY OF THE DISCLOSURE

The present application provides a dual mode ramjet or scramjet engine for an aircraft that includes an acoustic attenuator integrated in a combustion chamber of the dual mode ramjet or scramjet engine. The combustion chamber is connected to an inlet that is configured to receive and compress air as the aircraft travels in a forward direction. In the combustion chamber, the compressed air is mixed with fuel in the chamber to pressurize the engine. The acoustic attenuator includes one or more resonator cavities that are integrated into the wall of the combustion chamber. The resonator cavities face inwardly toward the combustion chamber to provide radial damping for stabilizing the engine and the aircraft.

Advantageously, the acoustic attenuator is configured to modify the acoustic characteristics of the combustion chamber to damp acoustic energy and decouple the acoustic energy from the input thermal energy. Modifying the acoustic characteristics reduces the combustion noise in the dual mode ramjet or scramjet engine that may otherwise generate vibration and unsteadiness of the engine that damages the engine or other components of the aircraft.

The shapes, sizes, and arrangements of the resonator cavities may be selected to suppress a specific acoustic signature of the combustion chamber. For example, a depth of the resonator cavity may be selected to achieve a predetermined damping characteristic such as damping or eliminating predetermined waves. In an exemplary embodiment, the acoustic attenuator may be formed as an array of resonator cavities that extend along an entire length of the perimeter of the wall from a front surface to a back surface of the combustion chamber. The array may include resonator cavities having the same or different three-dimensional shapes, such as cavities with different depths and widths. The resonator cavities may be configured as Helmholtz resonators, quarterwave resonators, or intermediate or generalized resonators. In exemplary embodiments, the array of resonator cavities may be configured to cover an entire surface of the combustion chamber.

In another exemplary embodiment of the acoustic attenuator, the resonator cavities may be formed as partitioned cavities that are arranged at the corners of the wall of the combustion chamber proximate the front and back surface of the combustion chamber. Entrances from the combustion chamber to the partitioned cavities may be contoured or rectangle. The cavity may be formed as a ring-like array.

The acoustic attenuator may be integrally formed as a monolithic part with the wall of the combustion chamber. In other exemplary embodiments, the acoustic attenuator may be permanently attached to the wall by brazing or welding. Integrating the acoustic attenuator into the combustion chamber is advantageous in that the acoustic attenuator is configured to withstand the high pressure and high temperature environment of the dual mode ramjet or scramjet engine, such as pressures that are between 10 and 100 psi and temperatures that are between 4500 and 8000 degrees Fahrenheit.

According to an aspect of the disclosure, a dual mode ramjet or scramjet engine includes an acoustic attenuator integrated in a combustion chamber of the engine.

According to an aspect of the disclosure, a dual mode ramjet or scramjet engine includes one or more resonant cavities that are formed integrally in a wall of a combustion chamber of the engine.

According to an aspect of the disclosure, a dual mode ramjet or scramjet engine includes an acoustic attenuator formed by an array of resonant cavities that extend along a perimeter of a wall of a combustion chamber of the engine.

According to an aspect of the disclosure, a dual mode ramjet or scramjet engine includes an acoustic attenuator formed by a resonator ring array arranged at a corner of a combustion chamber of the engine.

According to an aspect of the disclosure, a method of manufacturing a dual mode ramjet or scramjet engine includes integrating an acoustic attenuator in a combustion chamber of the engine.

According to an aspect of the disclosure, a method of manufacturing a dual mode ramjet or scramjet engine includes selecting a shape, size, and position of the resonant cavities along a combustion chamber in an acoustic attenuator for the combustion chamber of the engine to achieve a predetermined damping characteristic.

According to an aspect of the disclosure, a dual mode ramjet or scramjet engine includes an inlet configured to receive and compress air, a combustion chamber fluidly connected to the inlet and configured to mix the compressed air with fuel to pressurize the dual mode ramjet or scramjet engine, and an acoustic attenuator having one or more resonator cavities integrated into the combustion chamber.

According to an embodiment of any paragraph(s) of this summary, the one or more resonator cavities is configured to face inwardly toward the combustion chamber.

According to an embodiment of any paragraph(s) of this summary, the one or more resonator cavities is formed along an outer perimeter of a wall of the combustion chamber.

According to an embodiment of any paragraph(s) of this summary, the one or more resonator cavities includes a plurality of resonator cavities that form an array arranged along at least a portion of a length of the combustion chamber between a front surface and a rear surface of the combustion chamber.

According to an embodiment of any paragraph(s) of this summary, the array covers an entire surface area of the combustion chamber.

According to an embodiment of any paragraph(s) of this summary, the plurality of resonator cavities includes resonator cavities having different shapes.

According to an embodiment of any paragraph(s) of this summary, the acoustic attenuator includes one or more apertures that fluidly connect the plurality of resonator cavities with the combustion chamber.

According to an embodiment of any paragraph(s) of this summary, at least one of the plurality of resonator cavities has a width that is wider than a width of a corresponding one of the one or more apertures.

According to an embodiment of any paragraph(s) of this summary, at least one of the plurality of resonator cavities is formed as a closed slot that is connected to the combustion chamber and has a uniform cross-sectional area.

According to an embodiment of any paragraph(s) of this summary, the one or more resonator cavities is arranged at a corner of the combustion chamber proximate a front surface or a rear surface of the combustion chamber.

According to an embodiment of any paragraph(s) of this summary, the one or more resonator cavities is formed as a ring-like array that extends radially around the combustion chamber.

According to an embodiment of any paragraph(s) of this summary, the one or more resonator cavities is formed as a partitioned cavity that is fluidly connected to the combustion chamber by an entrance formed at a corner of the combustion chamber.

According to an embodiment of any paragraph(s) of this summary, the entrance is contoured.

According to an embodiment of any paragraph(s) of this summary, the entrance is rectangled.

According to an embodiment of any paragraph(s) of this summary, the acoustic attenuator is integrally formed as a monolithic part with the combustion chamber.

According to an embodiment of any paragraph(s) of this summary, the dual mode ramjet or scramjet engine is arranged in an aircraft for propulsion of the aircraft.

According to another aspect of the disclosure, a method of manufacturing a dual mode ramjet or scramjet engine for an aircraft includes integrating an acoustic attenuator into a combustion chamber of the dual mode ramjet or scramjet engine, the combustion chamber being connected to an inlet that is configured to receive and compress air, the combustion chamber configured to mix the compressed air with fuel to pressurize the dual mode ramjet or scramjet engine for propulsion of the aircraft, and forming the acoustic attenuator to have at least one resonator cavity that faces inwardly toward the combustion chamber for damping in a radial direction.

According to an embodiment of any paragraph(s) of this summary, the method includes selecting a shape, size, and position along the combustion chamber of the at least one resonator cavity to achieve a predetermined damping characteristic including damping or eliminating predetermined waves.

According to an embodiment of any paragraph(s) of this summary, forming the acoustic attenuator to have at least one resonator cavity includes forming an array of resonator cavities disposed about a perimeter of the combustion chamber.

According to an embodiment of any paragraph(s) of this summary, integrating the acoustic attenuator into the combustion chamber includes one of integrally forming the acoustic attenuator as a monolithic part with the combustion chamber, or permanently brazing or welding the acoustic attenuator to the combustion chamber.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF DRAWINGS

The annexed drawings, which are not necessarily to scale, show various aspects of the disclosure.

FIG. 1 shows a schematic drawing of a dual mode ramjet or scramjet engine that is used for propulsion of an aircraft and includes an acoustic attenuator.

FIG. 2 shows the acoustic attenuator in the dual mode ramjet or scramjet engine of FIG. 1 according to an exemplary embodiment of the present application in which the acoustic attenuator includes an array of resonator cavities.

FIG. 3 shows the acoustic attenuator in the dual mode ramjet or scramjet engine of FIG. 1 according to another exemplary embodiment of the present application in which the acoustic attenuator includes a partitioned cavity with a contoured entrance.

FIG. 4 shows a resonator of the acoustic attenuator in the dual mode ramjet or scramjet engine of FIG. 1 according to still another exemplary embodiment of the present application in which the acoustic attenuator includes a partitioned cavity with a rectangled entrance.

FIG. 5 shows a flowchart illustrating a method of manufacturing a dual mode ramjet or scramjet engine, such as the dual mode ramjet or scramjet engine of FIG. 1.

### DETAILED DESCRIPTION

The principles described herein have application in a dual mode ramjet or scramjet engine that may be attached to any suitable aircraft. A suitable aircraft may be a high speed aircraft that is capable of flying from approximately Mach 2 up to Mach 14. The dual mode ramjet or scramjet engine has a first mode in which the dual mode ramjet operates as a ramjet with subsonic combustion, and in a second mode in which the dual mode ramjet operates as a scramjet with supersonic combustion. For example, the ramjet may operate at speeds of around Mach 3 when in the first mode and transform into a scramjet over the Mach 4-8 range when in the second mode. Accordingly, the dual mode ramjet or scramjet engine is advantageously operable in both subsonic and supersonic combustor modes.

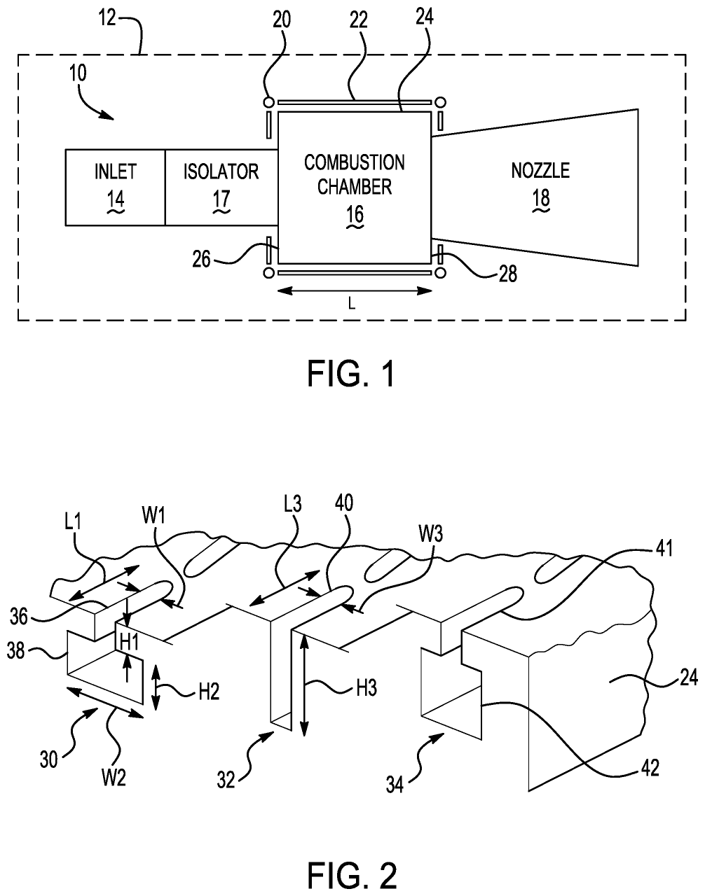

Referring first to FIG. 1, a dual mode ramjet or scramjet engine 10 may be arranged in any suitable aircraft 12, such as a high speed aircraft, for propulsion of the aircraft 12. The dual mode ramjet or scramjet engine 10 includes an inlet 14, a combustion chamber 16 downstream of the inlet 14, and a nozzle 18 downstream of the combustion chamber 16. The inlet 14 is configured to intake surrounding air and compress the air during forward movement of the aircraft 12. The dual mode ramjet or scramjet engine 10 uses the forward motion of the aircraft 12 to compress the incoming air for combustion without a rotating compressor.

The combustion chamber 16 is fluidly connected to the inlet 14 to receive the compressed air. In the combustion chamber 16, heat is added to the compressed air by adding fuel and burning the fuel. In an exemplary embodiment, to isolator 17 may be disposed between the inlet 14 and the combustion chamber 16 such that the isolator 17 interfaces with the combustion chamber 16. Some or all of the fuel may be injected from the isolator 17 into the combustion chamber 16 via injectors arranged at the downstream end of the isolator 17. Using the injectors may enhance mixing of the fuel and the compressed air. In the nozzle 18, the density of the air is decreased to increase the acceleration of the heated air and produce thrust for the aircraft 12.

The dual mode ramjet or scramjet engine 10 includes an acoustic attenuator 20, 22 that is integrated into the combustion chamber 16 to attenuate noise in the combustion chamber 16 that occurs during normal operation of the dual mode ramjet or scramjet engine 10. The acoustic attenuator 20, 22 includes one or more resonator cavities that are disposed on an outer perimeter or rim of a wall 24 of the combustion chamber 16. The resonator cavities are fluidly connected to the combustion chamber 16 and formed to face inwardly toward the combustion chamber 16 for damping in the radial direction.

The acoustic attenuator 20, 22 includes one or more three-dimensional cavities that are dimensioned to remove oscillatory energy from the system, i.e. to provide damping and to control combustion stability. Any dimensions and shapes may be suitable for the resonator cavities of the acoustic attenuator 20, 22 and the dimensions and shapes may be dependent on the application and the acoustic signature of the combustion chamber 16 that is to be suppressed. The cavities may be sized, shaped, and arranged relative to the combustion chamber 16 to damp or eliminate predetermined waves.

Integrating the acoustic attenuator 20, 22 into the combustion chamber 16 of the dual mode ramjet or scramjet engine 10 is advantageous in that attenuating the noise in the combustion chamber 16 reduces or eliminates vibrations that may cause damage to the engine or to other components of the aircraft 12 that are outside of the engine, such as avionics or actuators. Eliminating the vibrations provides stability and reduces unsteadiness of the dual mode ramjet or scramjet engine 10 and thus the aircraft 12. The acoustic attenuator 20, 22 is advantageously integrated directly into the combustion chamber 16 such that the normal function of the engine is not impacted by the acoustic attenuator 20, 22. For example, the acoustic attenuator 20, 22 may be formed as one monolithic part with the combustion chamber 16.

The combustion chamber 16 may have any suitable shape, such as cylindrical or rectangular, and is formed of any suitable material. For example, the combustion chamber 16 may be formed of a metal material that is configured to withstand temperatures of up to 8000 degrees Fahrenheit. The acoustic attenuator 20, 22 may be formed integrally as a single and continuous monolithic part with the wall 24 of the combustion chamber 16, or permanently attached to the combustion chamber 16. For example, the acoustic attenuator 20, 22 may be formed separately and brazed or welded to the wall 24. Forming the acoustic attenuator 20, 22 integrally with the wall 24 may be advantageous since the high pressure and temperature environment in which the dual mode ramjet or scramjet engine 10 is operable, e.g. 10 psi to 100 psi and 4500 to 8000 degrees Fahrenheit, may not lend itself to easily forming joints.

In an exemplary embodiment of the acoustic attenuator 20, the acoustic attenuator 20 may include a resonator cavity that is formed as a ring-like array that extends radially around the circumference or outer perimeter of the combustion chamber 16. The ring may be formed proximate a surface 26 of the combustion chamber 16 that faces away from the isolator 17 and/or a surface 28 of the combustion chamber 16 that faces the nozzle 18. The ring may include a single entrance that is fluidly connected between a corner of the combustion chamber 16 and the ring. The entrance may accommodate only a portion of the wall 24 whereas the ring may extend along the entire circumference, such that the ring wraps around the combustion chamber 16. The portion of the wall 24 accommodated by the entrance may be selected depending on a predetermined damping characteristic to be achieved by the acoustic attenuator 20. More than one ring and entrance may be provided, such as at both the surface 26 and the surface 28, and the shape of the rings and entrances may be the same or different.

In other exemplary embodiments, the acoustic attenuator 22 may be formed as a plurality of resonator cavities that form an array that is distributed along the wall 24 of the combustion chamber 16. The array of resonator cavities may extend along a portion of or an entire length L of the combustion chamber 16 that extends from the front surface 26 to the rear surface 28. In an exemplary embodiment, the array may be arranged to cover an entire surface of the wall 24 of the combustion chamber 16. In other exemplary embodiments, the resonator cavities may be arranged in a row along a portion of the length L of the combustion chamber 16. Each resonator cavity may have a same shape or a different shape and each resonator cavity may be connected to the combustion chamber 16 via a separate entrance. The resonator cavity entrance may accommodate only a portion of the wall 24 of the combustion chamber 16 and the portion accommodated by the entrance may be selected based on the desired damping characteristics for the acoustic attenuator 22.

Referring now to FIG. 2, exemplary configurations for the acoustic attenuator 22 are shown. FIG. 2 shows an array of resonator cavities that may include a Helmholtz resonator 30, a quarterwave resonator 32, and/or an intermediate or generalized resonator 34. The configurations shown in FIG. 2 are merely exemplary and many other shapes may be suitable for the resonator cavities. The array may include one type of resonator element or multiple types of resonator elements, and one or more of a single type of resonator element may be used.

Any number of resonator elements may be used. The resonator elements may be arranged in an ordered or repeating pattern, such that the resonator elements are evenly distributed about the combustion chamber 16 (shown in FIG. 1), or in a disordered pattern. As shown in FIG. 2, each of the resonator elements 30, 32, 34 may be formed integrally with the same wall 24 as a continuous and monolithic part. The resonator cavities of the array may be formed in an arrangement in which the resonator cavities extend normal to the wall 24. In other exemplary embodiments, the resonator cavities may be angled or bent relative to the wall 24.

The Helmholtz resonator 30 includes a neck or aperture 36 that is fluidly connected between the combustion chamber 16 and forms an entrance to a resonator cavity 38, such that the resonator cavity 38 faces inwardly toward the combustion chamber 16. The Helmholtz resonator 30 is shaped to provide one acoustic resonance. The aperture 36 has a width W1 that is less than a length L1 of the aperture 36 such that the aperture 36 is elongated. The aperture 36 may be arranged normal relative to the wall 24 or may be angled relative to the wall 24. The aperture may have a uniform width W1 across its length L1 in exemplary embodiments. In other embodiments, the width may be tapered, wavy, or otherwise varied. A height H1 of the aperture 36 is less than the length L1 and extends from the opening of the aperture 36 to the resonator cavity 38.

The resonator cavity 38 has a width W2 and a height H2 that is greater than the width W1 and the height H1 of the aperture 36, respectively. The height H2 of the resonator cavity 38 in the radial direction may be greater than the height H1 of the aperture 36. In exemplary embodiments, the resonator cavity 38 may be rectangular in shape, but other shapes may be suitable, such as tubular or spherical. The Helmholtz resonator 30 is dimensioned such that the dimensions of the resonator cavity 38 are larger as compared with the width of the aperture 36, but small compared with a wavelength. Other configurations of the Helmholtz resonator 30 may be suitable. A resonance frequency f of the Helmholtz resonance for the Helmholtz resonator 30 may be determined using equation 1:

$$f = \frac{c}{2 π} \sqrt{\frac{A}{V l}} \qquad Equation ( 1 )$$

In equation (1), the resonance frequency f is determined based on the speed of sound in air c, the length/and the area A of the aperture 36, and the volume V of the resonator cavity 38. Accordingly, a desired resonance frequency for the Helmholtz resonator 30 may be achieved by adjusting the dimensions of the Helmholtz resonator 30 in equation (1).

The quarterwave resonator 32 includes a single closed slot 40 that is fluidly connected to the combustion chamber 16. The closed slot 40 is elongated in the radial direction, having a height H3 and a uniform width W3. In other exemplary embodiments, the closed slot 40 may be angled relative to the combustion chamber 16. The width W3 of the closed slot 40 is less than the length L3 of closed slot 40. The closed slot 40 is shown as having a uniform cross-sectional area along the closed slot 40, but in other exemplary embodiments, the closed slot 40 may have a varying shape. Rectangular, tubular, or other shapes may be suitable for the closed slot 40.

The intermediate or generalized resonator 34 is similar to the Helmholtz resonator 30 in that the intermediate or generalized resonator 34 includes an aperture 41 connected between the combustion chamber 16 and a resonator cavity 42. As compared with the Helmholtz resonator 30, the resonator cavity 42 has an elongated height in the radial direction that is longer as compared with the width of the resonator cavity 42.

Similar to the Helmholtz resonator 30, the dimensions of both the quarterwave resonator 32 and the intermediate or generalized resonator 34, or any other resonator may be adjusted to achieve a predetermined resonance. For example, the dimensions may be selected to damp various waves. Using a closed slot having a uniform cross-sectional area may be particularly advantageous to damp a discrete tone. The Helmholtz resonator having a wider cross-sectional volume as compared with the aperture will damp noise content across a broader frequency range.

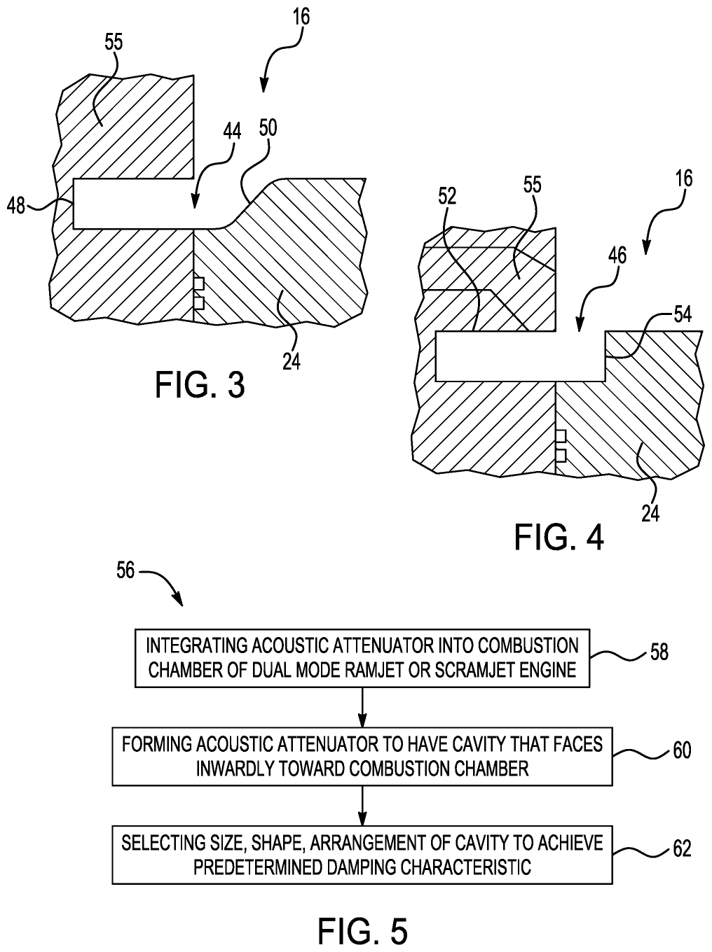

Referring now to FIGS. 3 and 4, exemplary embodiments of the acoustic attenuator 20 in FIG. 1 are shown. The acoustic attenuator 20 may include the acoustic attenuators 44, 46. Each acoustic attenuator 44, 46 includes an acoustic-slot type of absorber that has a partitioned annular cavity formed in the wall 24 of the combustion chamber 16 and facing inwardly toward the combustion chamber 16. The partitioned cavity may extend radially around the entire circumference of the combustion chamber 16 as a single continuous ring formed at the front surface or the rear surface of the combustion chamber 16. The partitioned cavity may have any suitable three-dimensional shape.

A damper array, as opposed to a ring-like array, may be implemented at a location where there is a sound wave that is interacting with the combustion process. The ring-like array may be used if there is a localized issue at the end of the combustor. The ring placement may be used where the front end of the combustor is an array of injectors and sound waves moving across that surface are interacting with the injector spray. Conversely, the dampers may be distributed along the length of combustor if the noise generation process is distributed.

As shown in FIG. 3, the acoustic attenuator 44 includes a partitioned cavity 48 having a contoured entrance 50 between the combustion chamber 16 and the partitioned cavity 48. The contoured entrance 50 may be formed at a corner of the combustion chamber 16. As shown in FIG. 4, the acoustic attenuator 46 includes a partitioned cavity 52 having a rectangled entrance 54 between the combustion chamber 16 and the partitioned cavity 52. The rectangled entrance 54 may be formed at a corner of the combustion chamber 16.

The entrance to the partitioned cavity 48, 52 may have any suitable three-dimensional shape other than contoured or rectangular and the entrance may be formed at a location other than the corner of the combustion chamber 16. In exemplary embodiments, the isolator 17 adjacent the combustion chamber 16 (shown in FIG. 1) may include an injector 55 for fuel such that the partitioned cavity may be formed adjacent the injector 55. The partitioned cavity may be formed as part of both the injector 55 and the wall 24 of the combustion chamber 16.

Referring now to FIG. 5, a flowchart illustrating a method 56 of manufacturing a dual mode ramjet or scramjet engine, such as the dual mode ramjet or scramjet engine 10 of FIG. 1, is shown. Step 58 of the method 56 includes integrating an acoustic attenuator 20, 22 into a combustion chamber 16 of the dual mode ramjet or scramjet engine 10. The dual mode ramjet or scramjet engine 10 may be arranged in an aircraft 12. The combustion chamber 16 is connected to an inlet 14 that is configured to receive and compress air as the aircraft 12 has forward motion through the air. The combustion chamber 16 is configured to mix the compressed air with fuel in the combustion chamber 16 to pressurize the dual mode ramjet or scramjet engine 10 for propulsion of the aircraft 12.

Step 58 of the method 56 may include integrally forming the acoustic attenuator 20, 22 as a monolithic part with the combustion chamber 16, or permanently brazing or welding the acoustic attenuator 20, 22 to the combustion chamber 16. The combustion chamber 16 may be formed using any suitable manufacturing process. For example, the combustion chamber 16 may be formed using machining or any other suitable metal forming processes. Additive manufacturing may be suitable for forming the combustion chamber 16. Additive manufacturing may be particularly advantageous in forming resonant cavities having complex resonant cavity structures.

Step 60 of the method 56 includes forming the acoustic attenuator 20, 22 to have at least one cavity that faces inwardly toward the combustion chamber 16 for damping in a radial direction. Step 60 may include forming a plurality of resonators disposed about a perimeter of the combustion chamber 16. Step 62 of the method 56 may include selecting a size, shape, and arrangement of the cavity to achieve a predetermined damping characteristic including at least one of damping or eliminating predetermined waves. For example, the depth of the cavity may be selected to damp various waves.

Although the disclosure shows and describes certain preferred embodiment or embodiments, it is obvious that equivalent alterations and modifications will occur to others skilled in the art upon the reading and understanding of this specification and the annexed drawings. In particular regard to the various functions performed by the above described elements (external components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A dual mode ramjet or scramjet engine comprising:
an inlet configured to receive and compress air;
a combustion chamber fluidly connected to the inlet and configured to mix the compressed air with fuel to pressurize the dual mode ramjet or scramjet engine; and
an acoustic attenuator having one or more resonator cavities integrated into the combustion chamber.

2. The dual mode ramjet or scramjet engine according to claim 1, wherein the one or more resonator cavities is configured to face inwardly toward the combustion chamber.

3. The dual mode ramjet or scramjet engine according to claim 1, wherein the one or more resonator cavities is formed along an outer perimeter of a wall of the combustion chamber.

4. The dual mode ramjet or scramjet engine according to claim 3, wherein the one or more resonator cavities includes a plurality of resonator cavities that form an array arranged along at least a portion of a length of the combustion chamber between a front surface and a rear surface of the combustion chamber.

5. The dual mode ramjet or scramjet engine according to claim 4, wherein the array covers an entire surface area of the combustion chamber.

6. The dual mode ramjet or scramjet engine according to claim 4, wherein the plurality of resonator cavities includes resonator cavities having different shapes.

7. The dual mode ramjet or scramjet engine according to claim 4, wherein the acoustic attenuator includes one or more apertures that fluidly connect the plurality of resonator cavities with the combustion chamber.

8. The dual mode ramjet or scramjet engine according to claim 7, wherein at least one of the plurality of resonator cavities has a width that is wider than a width of a corresponding one of the one or more apertures.

9. The dual mode ramjet or scramjet engine according to claim 4, wherein at least one of the plurality of resonator cavities is formed as a closed slot that is connected to the combustion chamber and has a uniform cross-sectional area.

10. The dual mode ramjet or scramjet engine according to claim 1, wherein the one or more resonator cavities is arranged at a corner of the combustion chamber proximate a front surface or a rear surface of the combustion chamber.

11. The dual mode ramjet or scramjet engine according to claim 10, wherein the one or more resonator cavities is formed as a ring-like array that extends radially around the combustion chamber.

12. The dual mode ramjet or scramjet engine according to claim 10, wherein the one or more resonator cavities is formed as a partitioned cavity that is fluidly connected to the combustion chamber by an entrance formed at a corner of the combustion chamber.

13. The dual mode ramjet or scramjet engine according to claim 12, wherein the entrance is contoured.

14. The dual mode ramjet or scramjet engine according to claim 12, wherein the entrance is rectangled.

15. The dual mode ramjet or scramjet engine according to claim 1, wherein the acoustic attenuator is integrally formed as a monolithic part with the combustion chamber.

16. The dual mode ramjet or scramjet engine according to claim 1, wherein the dual mode ramjet or scramjet engine is arranged in an aircraft for propulsion of the aircraft.

17. A method of manufacturing a dual mode ramjet or scramjet engine for an aircraft, the method comprising:
integrating an acoustic attenuator into a combustion chamber of the dual mode ramjet or scramjet engine, the combustion chamber being connected to an inlet that is configured to receive and compress air, the combustion chamber configured to mix the compressed air with fuel to pressurize the dual mode ramjet or scramjet engine for propulsion of the aircraft; and
forming the acoustic attenuator to have at least one resonator cavity that faces inwardly toward the combustion chamber for damping in a radial direction.

18. The method according to claim 17 further comprising selecting a shape, size, and position along the combustion chamber of the at least one resonator cavity to achieve a predetermined damping characteristic including damping or eliminating predetermined waves.

19. The method according to claim 17, wherein forming the acoustic attenuator to have at least one resonator cavity includes forming an array of resonator cavities disposed about a perimeter of the combustion chamber.

20. The method according to claim 17, wherein integrating the acoustic attenuator into the combustion chamber includes one of:
integrally forming the acoustic attenuator as a monolithic part with the combustion chamber; or
permanently brazing or welding the acoustic attenuator to the combustion chamber.
